(19) United States
(12) Patent Application Publication
(10) Pub. No.: US 2009/0103603 A1
(43) Pub. Date: Apr. 23, 2009

(54) SIMULCAST REPRODUCING METHOD

(75) Inventor: Takashi Hamano, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/248,965

(22) Filed: Oct. 10, 2008

(30) Foreign Application Priority Data
Oct. 19, 2007 (JP) 2007-272521

(51) Int. Cl. H04B 1/66

(52) U.S. Cl. 375/240.01

(57) ABSTRACT

According to an aspect of an embodiment, a method for reproducing moving pictures upon receiving simulcast first bit stream and second bit stream, the method comprising: receiving the first bit stream and the second bit stream simultaneously; decoding the first bit stream into a first moving picture comprising a first series of frames; decoding the second bit stream into a second moving picture a second series of frames; detecting an error in the first bit stream which disturbs reproduction of a particular frame from the first bit stream; and correcting the error in the first bit stream by supplementing correction data generated from data indicative of a difference between adjacent frames in the second moving picture, the correction data being used to reproduce a frame to replace the particular frame on the basis of a immediately preceding frame in the first picture.

### BACKGROUND

1. Field

This technique relates to picture correction performed by a terminal receiving a digital simulcast.

2. Description of the Related Art

The terrestrial digital television broadcast in Japan is transmitted in such a manner that the 6-MHz band of the ultra high frequency (UHF) is divided into 13 segments. The broadcast performed using 12 segments of the 13 segments is a 12-segment broadcast. A broadcast performed using the remaining one segment is a one-segment broadcast. In a 12-segment broadcast, moving pictures are encoded according to the MPEG-2 standardized by the International Organization for standardization (ISO), and each moving picture is high-definition, and high quality. In a one-segment broadcast, pictures are encoded according to the H.264 standardized by the International Telecommunication Union Telecommunication Standardization Sector (ITU-T). Since the frequency band used in a one-segment broadcast is narrow, the amount of data to be transmitted is small. Therefore, pictures with lower resolution than that in a 12-segment broadcast are broadcasted in a one-segment broadcast.

Incidentally, there are mobile terminals for receiving both a 12-segment broadcast and a one-segment broadcast. A typical example of such mobile terminals is an in-vehicle television. Currently, a 12-segment broadcast and a one-segment broadcast are simulcast, that is, the same picture information is broadcasted both in a 12-segment broadcast and in a one-segment broadcast simultaneously.

While high-quality pictures are broadcasted in a 12-segment broadcast, transmission errors often occur. For this reason, an error that has occurred in high-resolution picture data transmitted in a 12-segment broadcast is corrected using low-resolution picture data with few errors transmitted in a broadcast for mobile reception such as a one-segment broadcast. Means for performing such correction are disclosed in Japanese Unexamined Patent Application Publications Nos. 2004-336190 and 2002-232809. However, the correction means described in these related-art examples have the following problems.

That is, there is a large difference in quality between a high-resolution picture and a low-resolution picture. Especially, if an error occurs in a still picture area of a minute picture, a remarkable resolution reduction occurs locally. Further, when moving picture coding is performed in a digital broadcast, inter-frame prediction coding is used to compress the amount of information. Therefore, once an error has occurred in picture data, the error is propagated to subsequent frames and diffused. As a result, even if a frame where the error has occurred undergoes picture correction after the picture is decoded, errors in subsequent frames are uncorrectable.

### SUMMARY

According to an aspect of an embodiment, a method for reproducing moving pictures upon receiving simulcast first bit stream and second bit stream, the first bit stream being obtained by encoding a moving picture, the second bit stream being obtained by encoding the moving picture, the method comprising: receiving the first bit stream and the second bit stream simultaneously; decoding the first bit stream into a first moving picture comprising a first series of frames; decoding the second bit stream into a second moving picture a second series of frames; detecting an error in the first bit stream which disturbs reproduction of a particular frame from the first bit stream; and correcting the error in the first bit stream by supplementing correction data generated from data indicative of a difference between adjacent frames in the second moving picture, the correction data being used to reproduce a frame to replace the particular frame on the basis of a immediately preceding frame in the first picture.

### BRIEF DESCRIPTION OF THE DRAWINGS

FIG. 1 is a configuration diagram of a picture correction system 100 according to a first embodiment of the present invention;

FIG. 2 is a configuration diagram of a receiver 200 according to the first embodiment;

FIG. 3 is a configuration diagram of a correction means 203 according to the first embodiment;

FIG. 4 is a configuration diagram of a first decoder 201 according to the first embodiment;

FIG. 5 is a configuration diagram of a receiver 500 according to a second embodiment of the present invention;

FIG. 6 is a flowchart of transmission error detection processes performed by a variable-length decoding means 307 according to the second embodiment;

FIG. 7 is a flowchart of picture correction processes performed by the receiver 200 according to the second embodiment; and

FIG. 8 is a configuration diagram of a correction means 800 according to the second embodiment.

### DESCRIPTION OF THE PREFERRED EMBODIMENTS

### First Embodiment

In a first embodiment of the present invention, picture correction performed in a simulcast will be described using a simultaneous broadcast of a 12-segment broadcast and a one-segment broadcast as an example. In a 12-segment broadcast, pictures with a resolution higher than that of pictures in a one-segment broadcast are broadcasted. This is because a band used in a 12-segment broadcast is wider than that used in a one-segment broadcast so that a larger amount of data is transmitted and received in the 12-segment broadcast. The moving picture coding method used in a 12-segment broadcast is the MPEG-2 standardized by the ISO-IEC, while the moving picture coding method used in a one-segment broadcast is the H.264 standardized by the ITU-T (MPEG-4 part 10 standardized by ISO/IEC).

Picture correction according to this embodiment is picture correction in which a transmission error that has occurred in a 12-segment broadcast is corrected using information transmitted in a one-segment broadcast.

Configuration Diagram of Picture Correction System 100

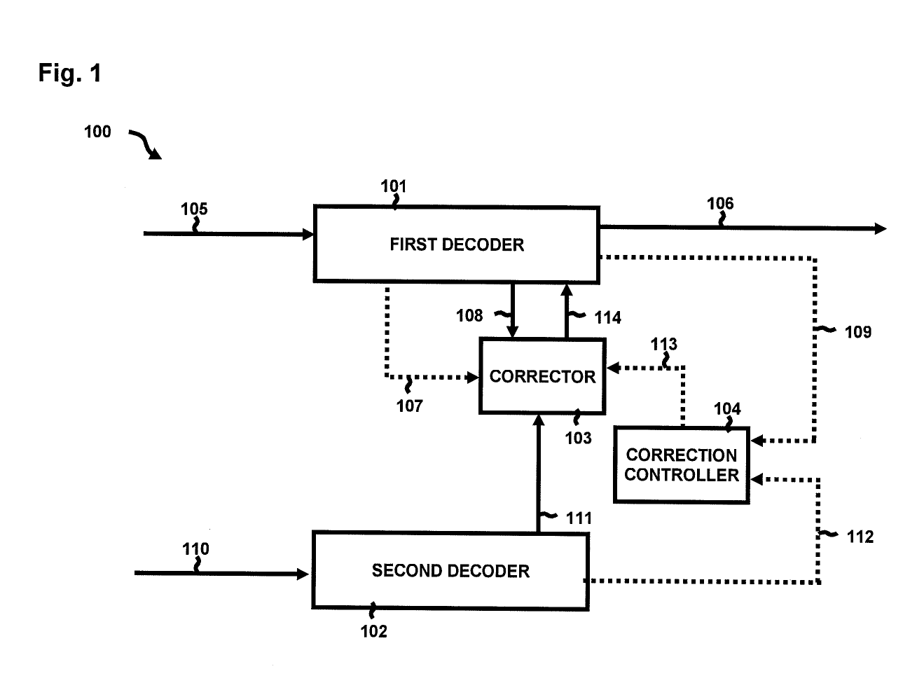

FIG. 1 is a configuration diagram of a picture correction system 100 according to this embodiment.

The picture correction system 100 includes a first decoder 101, a second decoder 102, a correction means (corrector) 103, and a correction control means (correction controller) 104.

The first decoder 101 receives a first bit stream 105. Simultaneously, the second decoder 102 receives a second bit stream 110.

The first bit stream 105 refers to encoded moving picture data, specifically, a bit string representing a moving picture transmitted in a 12-segment broadcast. The moving picture coding method used when the moving picture data is encoded into the first bit stream 105 is the MPEG-2. In other words, the first bit stream 105 is a bit string obtained by compressing a picture using the MPEG-2 method. Also, the first bit stream 105 is data obtained by encoding data representing a difference between frames. The first frames refer to frames into which the first decoder 101 has decoded the first bit stream 105. Also, the frames refer to pictures included in moving picture data into which the first decoder 101 has decoded the first bit stream 105. That is, the moving picture data includes multiple continuous frames. The MPEG-2 employs motion compensation inter-frame prediction coding in order to compress picture information. That is, according to the MPEG-2, pictures are compressed by subjecting data representing a difference between the first frames to motion compensation and encoding the resultant difference data.

The first decoder 101 decodes the received first bit stream 105 and outputs a decoded picture 106. Also, the first decoder 101 outputs decoding state information 107 and first decoding information 108 to a correction means 103. Further, the first decoder 101 outputs first decoding control information 109 to a correction control means 104.

The first decoder 101 outputs the decoded picture 106 according to decoded pixel data included in corrected decoding information 114 received from the correction means 103. The corrected decoding information 114 includes coding mode information generated by the correction means 103, decoded pixel data generated by the correction means 103, and motion vector information generated by the correction means 103. The preceding frame is stored in a frame memory included in the first decoder 101.

The decoding state information 107 includes decoding position information and decoding error information. The decoding position information refers to information indicating a position in a frame that the first decoder 101 is decoding. The decoding error information refers to information indicating whether an error has occurred in the first bit stream 105 in the decoding position.

The first decoding information 108 includes first coding mode information, first motion vector information, and first decoded pixel data.

The first coding mode information refers to information indicating whether the coding mode is intra-frame coding mode or inter-frame prediction coding mode. The first motion vector information refers to information indicating to what extent each pixel in a picture is moving in what direction. The first decoded pixel data refers to data indicating pixels in the first frame if the first coding mode information indicates intra-frame coding; it refers to data representing a difference between the first frames subjected to the motion compensation.

The first decoding control information 109 is information indicating the resolution of the first frame. In this embodiment, the resolution of the first frame decoded by the first decoder 101 is 640 pixels×480 lines. A macroblock includes a luminance block and two color difference blocks. The size of the luminance block in the macroblock is 16 pixels×16 lines. The size of the color block is 8 pixels×8 lines. Thus, the number of macroblocks in each first frame is 40×30. A discrete cosine transform (DCT) is performed in units of 8 pixels×8 lines in the luminance block.

The second bit stream 110 is also a stream of encoded moving picture data, specifically, a bit string representing a moving picture transmitted in a one-segment broadcast. The moving picture coding method used when the moving picture data is encoded into the second bit stream 110 is the H.264 standardized by the ITU-T. In other words, the second bit stream 110 is a bit string obtained by compressing a picture using the H.264 method Also, the second bit stream 110 is data obtained by encoding data representing a difference between continuous second frames. The second frames are frames into which the second decoder 102 has decoded the second bit stream 110. The H.264 method employs motion compensation inter-frame prediction coding in order to compress pictures. That is, according to the H.264, pictures are compressed by subjecting data representing a difference between the second frames to motion compensation and encoding the resultant difference data.

The second decoder 102 decodes the received second bit stream 110 and outputs second decoding information 111 to the correction means 103. Also, the second decoder 102 outputs second decoding control information 112 to the correction control means 104.

The second decoding information 111 includes second coding mode information, second motion vector information, and second decoded pixel data. The second decoding mode information 111 is information indicating whether the encoding mode is intra-frame coding mode or inter-frame prediction coding mode. The second motion vector information is information indicating to what extent each pixel in a picture is moving in what direction. The second decoded pixel data is pixel data in the second frame if the second coding mode information indicates intra-frame coding; the second decoded pixel data is data representing a difference between the second frames subjected to the motion compensation if the second coding mode information indicates inter-frame prediction coding.

The second decoding control information 112 is information indicating the rezolution of a picture decoded by the second decoder 102. In this embodiment, the resolution of a picture decoded by the second decoder 102 is 320 pixels×240 lines. A macroblock includes a luminance block and two color difference blocks. The size of the luminance block in the macroblock is 16 pixels×16 lines. The size of the color difference block is 8 pixels×8 lines. Thus, the number of macroblocks in each second frame is 20×15. A discrete cosine transform (DCT) is performed in units of 4 pixels×4 lines in the luminance block.

The second decoder 102 decodes the second bit stream 102 and calculates data representing a difference between the second frames. The second decoder 102 combines the difference data with the preceding second frame so as to generate a second decoded picture in the one-segment broadcast.

The correction control means 104 generates correction control information 113 from the first decoding control information 109 and second decoding control information 112. Then, the correction control means 104 outputs the correction control information 113 to the correction means 103. Specifically, the correction control means 104 associates the macroblock position of the first frame with that of the second frame that are different due to the difference in resolution between the first and second frames, on the basis of the first decoding control information 109 and second decoding control information 112. Then, the correction control means 104 outputs the correction control information 113 indicating the association between the respective macroblock positions of the first and second frames to the correction means 103.

The correction means 103 generates corrected decoding information 114 from the first decoding information 108, second decoding information 111, and correction control information 111. Then, the correction means 103 outputs the corrected decoding information 114.

The correction control information 113 includes block position association information indicating the association between the macroblock position of the first frame and that of the second frame and information indicating scaling based on a difference in resolution between the first and second frames. In other words, the block position association information is information indicating the position of the first frame decoded by the first decoder 101 and the position of the second frame decoded by the second decoder 102 corresponding to the decoded position of the first frame. That is, the block position association information is information for identifying a position in a second picture corresponding to a position in a first picture where a transmission error has occurred by associating the first frame decoded by the first decoder with the second frame decoded by the second decoder.

The scaling information is information for compensating for a difference in resolution between the first and second frames. Also, the scaling information is information indicating an enlargement ratio used when converting parameters indicating a macroblock position into parameters indicating a position of the first frame, as well as used when enlarging the decoded pixel data or motion vector of the second frame in accordance with the resolution of the first frame. Parameters indicating a macroblock position are, for example, the x and y coordinates relative to a reference point in each of the first and second frames.

In this embodiment, the resolution of the first frame and the number of macroblocks thereof and 640×480 and 40×30, respectively. The resolution of the second frame and the number of macroblocks thereof and 320×240 and 20×15, respectively. Therefore, one macroblock of the second frame corresponds to two macroblocks of the first frame in the vertical and horizontal directions and the enlarged ratio is twice in each of the vertical and horizontal directions.

The corrected decoding information 114 is information that the correction means 103 generates from the first decoding information 108 and second decoding information 111 according to the correction control information 113. The correction decoding means 114 includes coding mode information generated by the correction means 103, decoding picture data generated by the correction means 103, and a motion vector generated by the correction means 103.

In a receiver for receiving the simulcast first bit stream 105 and second bit stream 110 according to this embodiment, the first decoder 101 decodes the first bit stream 105 into the first frame and the second decoder 102 decodes the second bit stream into the second frame. A variable-length decoding means of the first decoder 101 detects an error area in the first frame. In response to the detection of an error area, the correction means 103 corrects data representing a difference between the first frames according to a difference between the second frame and a past second frame decoded by the second decoder 102 in the past so as to generate decoded pixel data. The first decoder 101 outputs the decoded picture 106 according to the decoded pixel data.

Thus, even if a transmission error occurs when decoding the first frame, the picture correction system 100 according to this embodiment reduces degradation in quality of an output picture.

### Configuration Diagram of Receiver 200

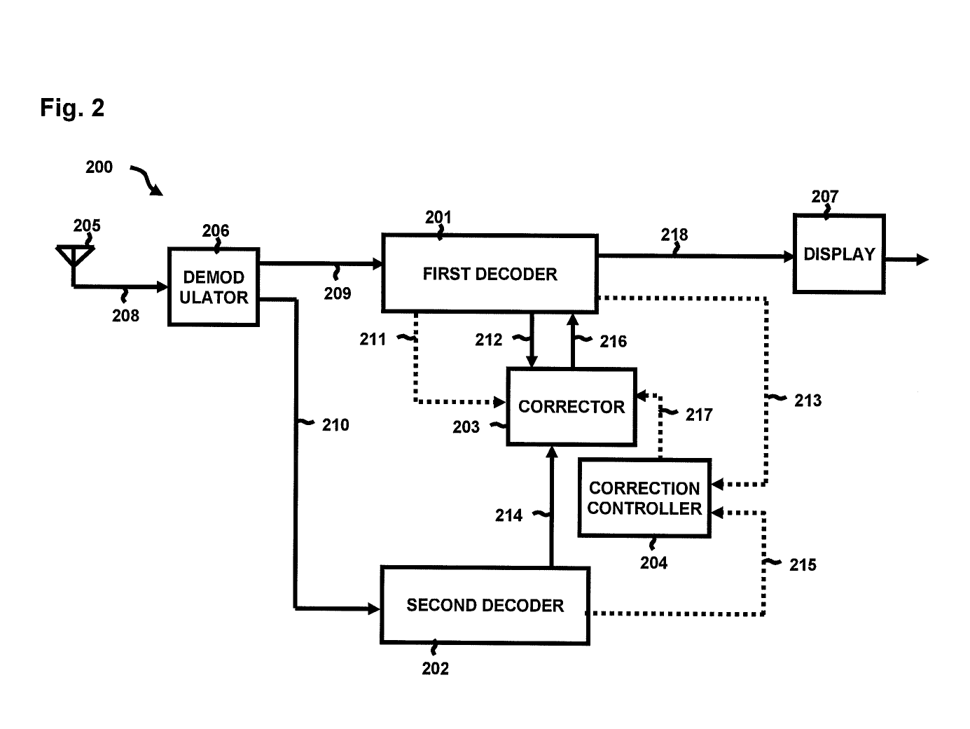

FIG. 2 is a configuration diagram of a receiver 200 for receiving simulcasts according to this embodiment.

The receiver 200 according to this embodiment includes a first decoder 201, a second decoder 202, a correction means 203, a correction control means 204, an antenna 205, a demodulator 206, and a display 207. The first decoder 201, second decoder 202, correction means 203, and correction control means 204 have functions similar to those of the corresponding components of the picture correction system 100 shown in FIG. 1.

Operations of the receiver 200 will be described while detailing the items described in the picture correction system 100.

The receiver 200 according to this embodiment receives encoded data 208 transmitted both in a 12-segment broadcast and in a one-segment broadcast using the antenna 205. Then, the demodulator 206 demodulates the encoded data 208 received by the antenna 205 to generate a first bit stream 209 and a second bit stream 210. The first bit stream 209 is a bit string representing a picture transmitted in the 12-segment broadcast. The second bit stream 210 is a bit string representing a picture transmitted in the one-segment broadcast.

The first decoder 201 receives the first bit stream 209, while the second decoder 202 receives the second bit stream 210.

Upon receipt of the first bit stream, the first decoder 201 transmits decoding state information 211 to the correction means 203. Also, the first decoder 201 transmits first decoding information 212 to the correction means 203. Further, the first decoder 201 transmits first decoding control information 213 to the correction control information 204.

Upon receipt of the second bit stream 210, the second decoder 202 transmits second decoding information 214 to the correction means 203. Also, the second decoder 202 transmits the second decoding control information 215 to the correction control means 204.

The first bit stream 209 is a bit string representing a picture compressed using the MPEG-2 standardized by the ISO/IEC and transmitted in the 12-segment broadcast. Specifically, the first bit stream 209 is a bit string obtained by encoding a prediction error (difference data) between a prediction picture generated using a motion vector and a target frame. The motion vector refers to information indicating to what extent a subject or the like has moved in the target frame. A motion vector resolution refers to the resolution of the motion vector in the target frame. The prediction picture refers to a picture in which the subject in the target frame has been shifted according to a motion of the subject. The first bit stream 209 includes data obtained by encoding a motion vector to be used to generate a prediction picture.

When a motion compensation inter-frame prediction is made, one frame is divided into multiple macroblocks and a motion vector is defined for each macroblock. Then, an encoder retrieves a prediction macroblock most similar to a macroblock to be encoded from among motion vectors in a prediction picture and then calculates a prediction error. Then, the encoder encodes the calculated prediction error.

The second bit stream 210 is a bit string representing a picture compressed using the H.264 standardized by the ITU-T and transmitted in the one-segment broadcast. Specifically, the second bit stream 210 is a bit string obtained by coding a prediction error (difference data) between a prediction picture generated using a motion vector and a target frame. The motion vector refers to information indicating to what extent a subject or the like has moved in the target frame. The prediction picture refers to a picture in which the subject in the target frame has been shifted according to a motion of the subject. The second bit stream 210 includes data obtained by encoding a motion vector to be used to generate a prediction picture.

When a motion compensation inter-frame prediction is made, one frame is divided into multiple macroblocks and a motion vector is defined for each macroblock. Then, an encoder retrieves a prediction block most similar to a macroblock to be encoded from among motion vectors in a prediction picture and then calculates a prediction error. Then, the encoder encodes the calculated prediction error.

The first decoder 201 decodes the received first bit stream 209, generates a decoded picture 218 using corrected decoding information 216 received from the correction means 203, and outputs the generated decoded picture 218. The display 207 displays the decoded picture 218 received from the first decoder 201 on a picture.

### Configuration Diagram of Correction Means 203

Next, a configuration of the correction means 203 shown in FIG. 2 and processes performed by the correction means 203 will be described in detail. The correction means 203 corrects a transmission error that has occurred in the first bit stream 209 received by the first decoder 201, using information generated from the second bit stream 210 by the second decoder 202.

The correction means 203 receives decoding state information 211 and first decoding information 212 from the first decoder 201. Also, the correction means 203 receives second decoding information 214 from the second decoder 202. Further, the correction means 203 receives correction control information 217 from the correction control means 204. Then, the correction means 203 generates the corrected decoding information 216 from the received pieces of information (decoding state information 211, first decoding information 212, second decoded information 214, and correction control information 217) and outputs the corrected decoding information 216 to the first decoder 201.

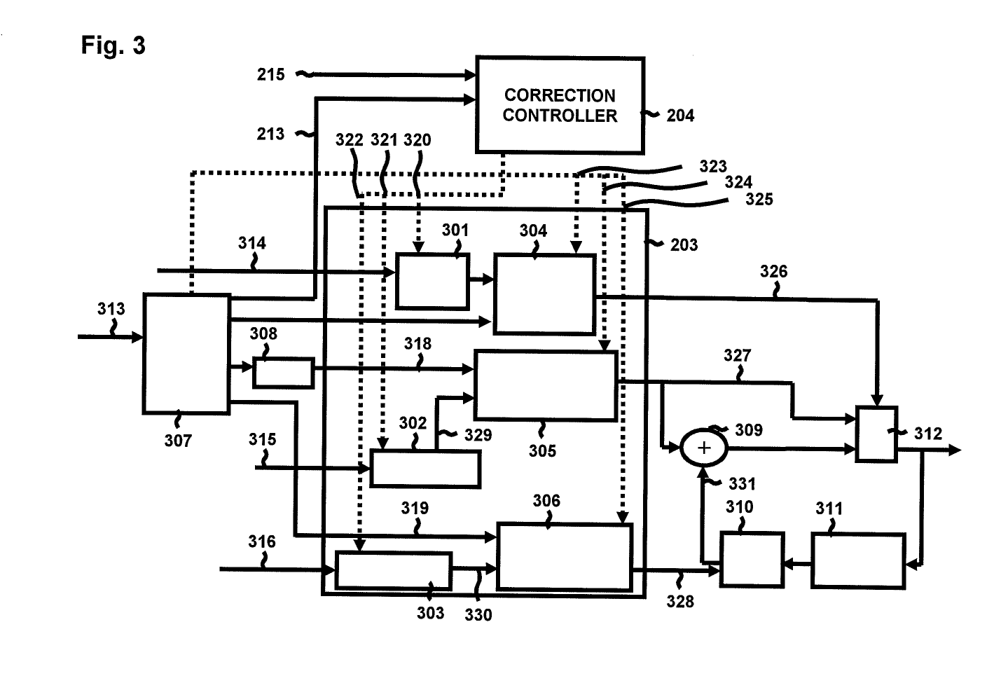

FIG. 3 is a detailed configuration diagram of the correction means 203 according to this embodiment.

The correction means 203 includes a block association means 301, scaling means 302 and 303, a coding mode rewrite means 304, a decoded pixel data replacement means 305, and a motion vector replacement means 306.

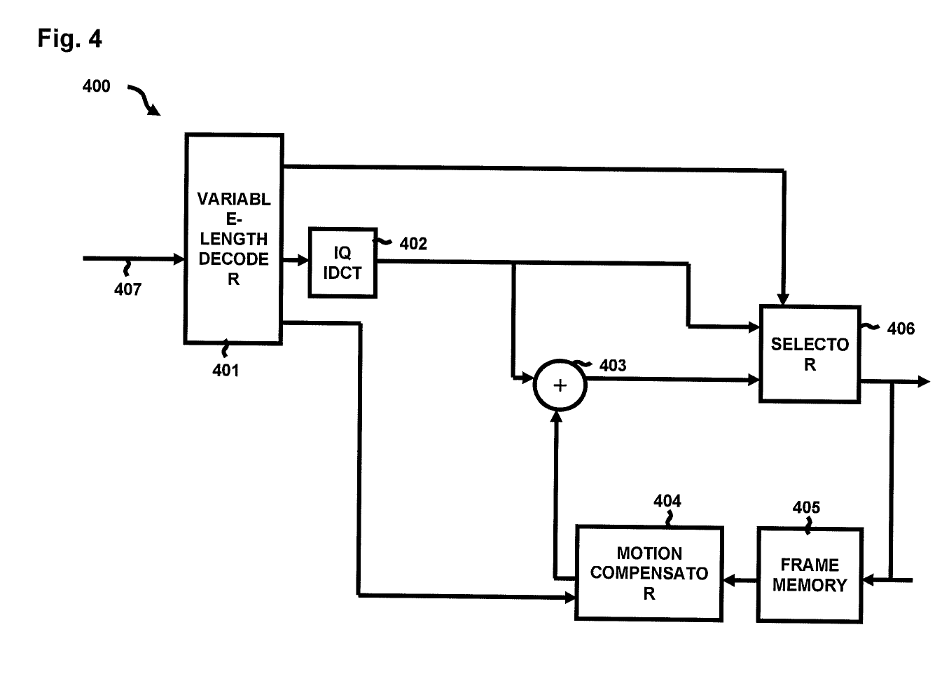

A variable-length decoding means 307, an IQ/IDCT (inverse quantization/inverse discrete cosine transform) 308, an adder 309, a motion compensation means 310, a frame memory 311, and a selection means 312, all of which are shown in FIG. 3, are included in the first decoder 210. FIG. 4 is a configuration diagram of the second decoder 202.

The second decoding information 214 includes second coding mode information 314, second decoded pixel data 315, and second motion vector information 316. The second coding mode information 314 is information indicating whether the coding mode is intra-frame coding mode or inter-frame prediction coding mode. The second decoded pixel data 315 is information indicating a prediction error (difference data) between the second frames. The second motion vector information 316 is information indicating to what extent each pixel in a picture is moving in what direction.

Upon receipt of the first decoding control information 213 and decoding control information 215, the correction control means 204 generates block position association information 320 and scaling information 321 and scaling information 322. Then, the correction control means 204 transmits the block position association information 320 to the block position association means 301. Also, the correction control means 204 transmits the scaling information 321 to the scaling means 302, as well as transmits the scaling information 322 to the scaling means 303.

The block position association information 320 is information indicating the association between the macroblock position of the first frame and that of the second frame. The scaling information 321 is information indicating an enlarged ratio used to compensate for a difference in resolution between the first and second frames. The scaling information 322 is information indicating an enlarged ratio used to compensate for a difference in scale between a motion vector of the first frame and that of the second frame.

Then, the block association means 301 receives the second coding mode information 314 from the second decoder 202. The block association means 301 associates the macroblock position of the first frame with that of the second frame using the block association position information 320 so as to identify the macroblock position of the second frame corresponding to that of the first frame. Then, the block association means 301 identifies coding mode of the identified macroblock position of the second frame on the basis of the second coding mode information 314. The identified the coding mode of the second frame is the coding mode of the macroblock position of the second frame corresponding to that of the first frame. Then, the block association means 301 transmits the coding mode corresponding to the identified macroblock position of the second frame to the coding mode rewrite means 304.

The coding mode rewrite means 304 receives first coding mode information 317 from the variable-length decoding means 307. Also, the coding mode rewrite means 304 receives decoding state information 323. Further, the coding mode rewrite means 304 receives the coding mode of the second frame corresponding to the first frame from the block association means 301. Thus, the coding mode rewrite means 304 replaces the coding mode of the macroblock position, where a transmission error has occurred, included in the first coding mode information 317 with the corresponding coding mode of the second frame according to decoding state information and then outputs coding mode information 326 to the selection means 312. The coding mode information 326 is information indicating whether the coding mode is intra-first frame coding mode or inter-first frame prediction coding mode. In the coding mode information 326, the macroblock position where the transmission error has occurred is the coding mode of the second frame.

The scaling means 302 receives the second decoded pixel data 315 from the second decoder 202. Also, the scaling means 302 receives the scaling information 321 from the correction control means 204. Then, according to the scaling information 321, the scaling means 302 converts parameters indicating the macroblock position of the second frame into parameters indicating the macroblock position of the first frame so as to enlarge the macroblock position of the second frame to the macroblock position of the first frame to generate the scaling decoded pixel data 329.

The decoded pixel data replacement means 305 receives first decoded pixel data 318 from the IQ/IDCT 308. Also, the decoded pixel data replacement means 305 receives decoding state information 324. Further, the decoded pixel data replacement means 305 receives the scaling information 329 from the scaling means 302. Then, the decoded pixel data replacement means 305 replaces the macroblock of the first frame where a transmission error has occurred with the enlarged macroblock of the second frame using the scaling information 329 and first decoded pixel data 318 so as to generate decoded pixel data 327. Then, the decoded pixel data replacement means 305 transmits the decoded pixel data 327 to the selection means 312 and adder 309.

The scaling means 303 receives the second motion vector information 316 from the second decoder 202. Also, the scaling means 303 receives the scaling information 322 from the correction control means 204. Then, the scaling means 303 identifies the motion vector of the macroblock position of the second frame for correcting the motion vector corresponding to the macroblock position of the first frame using the second motion vector information 316. Then, the scaling means 303 enlarges the identified motion vector of the macroblock position of the second frame to the scale of the motion vector of the macroblock position of the first frame so as to generate motion vector information 330. Then, the scaling means 303 transmits the motion vector information 330 to the motion vector replacement means 306.

The motion vector replacement means 306 receives first motion vector information 319 from the variable-length decoding means 307. Also, the motion vector replacement means 306 receives the decoding state information 323. Further, the motion vector replacement means 306 receives the motion vector information 330 from the scaling means 303. Then, the motion vector replacement means 306 transmits motion vector information 328 to the motion compensation means 310. The motion vector information 328 is information obtained by replacing the motion vector of the macroblock position, where a transmission error has occurred, included in the first motion vector information 319 with a motion vector obtained by enlarging the corresponding motion vector of the second frame to the scale of the motion vector of the macroblock position of the first frame. The correction means 203 is characterized in that it determines whether the transmission error position (error area) is a moving picture portion or a still picture portion on the basis of the motion vector information 319. More specifically, the motion vector replacement means 306 determines whether the macroblock where the transmission error has occurred is a moving picture portion or a still picture portion on the basis of the motion vector information 319. If the correction means 204 determines that the position where the transmission error has occurred is a still picture portion, the first decoder 201 outputs a first frame, in which the error has yet to occur, stored in the frame memory 311. Since the correction means 203 corrects the data representing a difference between the first frames using the data representing a difference between the second frames, the picture quality of the first frame degrades only by the difference data. Thus, degradation in picture quality due to correction is reduced.

The variable-length decoding means 307 decodes the first bit stream and transmits decoded macroblocks to the IQ/IDCT 308. Also, the variable-length decoding means 307 detects a transmission error that has occurred in the first bit stream. The transmission error is a transmission error that has occurred in a macroblock obtained by decoding the first bit stream.

Also, the variable-length decoding means 307 transmits the decoding state information 323, decoding state information 324, and decoding state information 325 to the coding mode rewrite means 304, decoded pixel replacement means 305, and motion vector replacement means 306. Further, the variable-length decoding means 307 transmits the first coding mode information 317 to the coding mode rewrite means 304. Furthermore, the variable-length decoding means 307 transmits the first motion vector information 319 to the motion vector replacement means 306. Here, the decoding state information 323, decoding state information 324, and decoding state information 325 is each information including decoding error information and decoding position information. Thus, the coding mode rewrite means 304, decoded pixel replacement means 305, and motion vector replacement means 306 each determine whether a transmission error has occurred in the first frame and, if a transmission error has occurred, identify the position where the error has occurred. Processes performed by an error detection unit described in the appended claims are included in processes performed by the variable-length decoding means 307 according to this embodiment.

The IQ/IDCT 308 performs a further decoding process by performing inverse-quantization and inverse-discrete cosine transform on the decoded first bit stream. Then, the IQ/IDCT 308 transmits the first decoded pixel data 318 to the decoded pixel data replacement means 305.

The frame memory 311 stores a frame 332 obtained by decoding the first bit stream. The frame 332 here refers to a frame based on decoded pixel data transmitted immediately before the decoded pixel data 327 is transmitted to the selection means 312 and adder 309 by the decoded pixel data replacement means 305.

The motion compensation means 310 receives the motion vector information 328 from the motion vector replacement means 306. Also, the motion compensation means 310 reads the frame 332 from the frame memory 311. Then, the motion compensation means 310 performs a motion compensation process on the frame 332 using the motion vector information 328 so as to generate a decoded picture 331. Then, the motion compensation means 310 transmits the decoded picture 331 to the adder 309.

The adder 309 adds the decoded picture 331 to the decoded pixel data 327. In the macroblock position where a transmission error has occurred, a prediction error (decoded pixel data) of the transmission error position of the first bit stream is corrected using a prediction error (decoded pixel data) of the second bit stream. That is, the corresponding data (decoded pixel data 327) representing a difference between the second frames used to correct the position where the transmission error has occurred is added to the decoded picture 331. Thus, degradation in the decoded picture is prevented. If the position where the transmission error has occurred in the first bit stream is a still picture portion, the data representing a difference between the second frames corresponding to the error position is “0.” As a result, the receiver 200 corrects the position where the transmission error has occurred, without causing degradation in the picture quality. Also, the adder 309 adds, to the decoded picture 331, the data representing a difference data between the second frames corresponding to the error occurrence position. Therefore, even if the position where the transmission error has occurred is a moving picture portion, the receiver 200 performs picture correction while reducing degradation in the picture quality compared with picture correction in which the error occurrence position is replaced directly with the corresponding second frame.

The selection means 312 selects any one of the decoded pixel data 327 and the decoded picture 331 outputted by the adder 309 according to the coding mode information 321 received from the coding mode rewrite means 304.

The correction means 203 may perform not only replacement according to only replacement control information from the correction control means 204 but also partial replacement such as locally determining whether the error position is a moving picture portion or a still picture portion using the second decoding information and, only if the error position is a moving picture portion, replacing only the motion vector.

In related-art picture correction techniques, picture correction is performed on a decoded picture where an error has occurred; therefore, errors in subsequent frames are uncorrectable in principle. On the other hand, the receiver 200 replaces the data representing a difference between the first frames where an error has occurred in the process of decoding the first bit stream with the corresponding data representing a difference between the second frames. Thus, the effect of the picture correction remains in subsequent pictures thereby preventing the propagation or diffusion of the error.

### Second Decoder 400

FIG. 4 is a configuration diagram of a second decoder 400 according to this embodiment.

The second decoder 400 includes a variable-length decoding means (variable-length decoder) 401, an IQ/IDCT 402, an adder 403, a motion compensation means (motion compensator) 404, a frame memory 405, and a selection means (selector) 406.

The variable-length decoding means 401 decodes a second bit stream 407. The decoded information includes the second coding mode information 314, second decoded pixel data 315, and second motion vector information 316.

The second decoder 400 transmits the second coding mode information 314, second decoded pixel data 315, and second motion vector information 316 to the correction means 203. That is, the second decoding information 214 includes the second coding mode information 314, second decoded pixel data 315, and second motion vector information 316.

The IQ/IDCT 402 performs inverse quantization and inverse discrete cosine transform on a block so as to generate the second decoded pixel data 315. Here, the second decoded pixel data 315 is information indicating the pixels of the second frame if the second coding mode information is intra-frame coding; the second decoded pixel data 315 is data representing a difference between the second frames subjected to motion compensation if the second coding mode information is inter-frame prediction coding. The frame memory 405 stores a frame preceding a frame outputted by the selection means 406. The motion compensation means 404 reads the preceding frame from the frame memory 405 and performs motion compensation using the second motion vector information 316 so as to generate a decoded picture. The adder 403 adds the decoded picture to the second decoded pixel data 315. The selection means 406 selects any one of the second decoded pixel data 315 and the decoded picture outputted by the adder 403 on the basis of the second coding mode information 314.

### Second Embodiment

Next, picture correction performed by a receiver 500 according to a second embodiment of the present invention will be described. The receiver 500 also corrects a transmission error that has occurred in a 12-segment broadcast using information transmitted in a one-segment broadcast.

### Configuration Diagram of Receiver 500

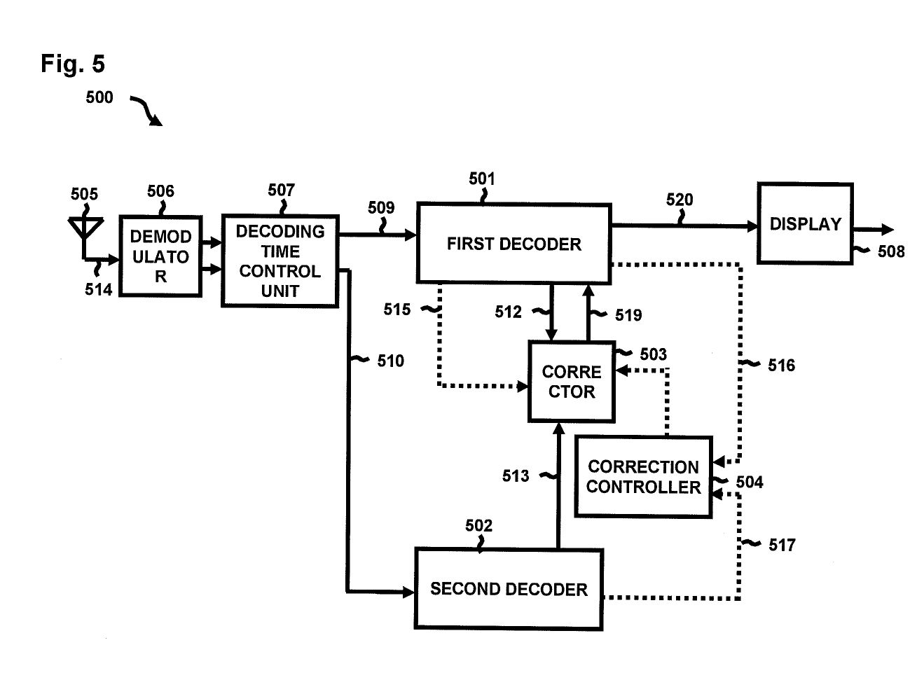

FIG. 5 is a configuration diagram of a receiver 500 according to this embodiment.

The receiver 500 includes a first decoder 501, a second decoder 502, a correction means 503, a correction control means 504, an antenna 505, a demodulator 506, a decoding time control unit 507, and a display 508. The decoding time control unit 507 adjusts the time when the first decoder 501 decodes a first bit stream and the time when the second decoder 502 decodes a second bit stream. The receiver 500 is different from the receiver 200 in that the receiver 500 includes the decoding time control unit 507.

### Decoding Time Control Unit 507

A first bit stream 509 and a second bit stream 510 both include playback time information 511. The playback time information 511 is information indicating the time when the first bit stream 509 and second bit stream 510 transmitted in the 12-segment broadcast and the one-segment broadcast are played back.

The decoding time control unit 507 transmits the first bit stream 509 and second bit stream 510 to the first decoder 501 and second decoder 502, respectively, while synchronizing these streams using the playback time information 511. That it, the decoding time control unit 507 performs a wait operation on the first bit stream 509 and second bit stream 510. The first decoder 501 decodes the first bit stream 501. Simultaneously, the second decoder 502 decodes the second bit stream 502.

Thus, the correction means 503 acquires the first decoding information 512 from the first decoder 501 and second decoding information 513 from the second decoder 502 in synchronization. Or, the receiver 500 may detect scene changes of the first bit stream 509 and second bit stream 510 instead of using the playback time information 511 so as to synchronize these streams. Thus, the receiver 500 synchronizes the first decoder 501 and second decoder 502.

The receiver 500 receives encoded data 514 transmitted in the 12-segment broadcast and the one-segment broadcast using the antenna 505. The demodulator 507 demodulates the encoded data 514 received by the antenna 505 to generate the first bit stream 509 and second bit stream 510. The first bit stream 509 is a bit string representing a picture transmitted in the 12-segment broadcast, while the second bit stream 510 is a bit string representing a picture transmitted in the one-segment broadcast.

The decoding time control unit 507 transmits the first bit stream 509 and second bit stream 510 to the first decoder 501 and second decoder 502, respectively, while synchronizing these streams.

Upon receipt of the first bit stream 509, the first decoder 501 transmits the first decoding information 512 to the correction means 503. Also, the first decoder 510 transmits the first decoding state information 515 to the correction means 503. Further, the first decoder 510 transmits first correction control information to the correction control means 504.

Upon receipt of the second bit stream 510, the second decoder 502 transmits the second decoding information 513 to the correction means 503. Also, the second decoder 502 transmits the second decoding control information 517 to the correction control means 504.

The first bit stream 509 is a bit string representing a picture compressed using the MPEG-2 standardized by the ISO/IEC and transmitted in the 12-segment broadcast. Specifically, the first bit stream 509 is a bit string obtained by encoding a prediction error (difference data) between a prediction picture generated using a motion vector and a target frame. Similarly, the second bit stream 510 is a bit string representing a picture compressed using the H.264 standardized by the ITU-T and transmitted in the one-segment broadcast. Specifically, the second bit stream 510 is a bit string obtained by encoding a prediction error (difference data) between a prediction picture generated using a motion vector and a target frame.

The first decoder 501 decodes the received first bit stream 509 and generates a decoded picture 520 using corrected decoding information 519 received from the correction means 503 and outputs the generated decoded picture 520. The display 508 displays the decoded picture 520 received from the first decoder 501 on a screen.

### Flowchart of Error Detection Processes

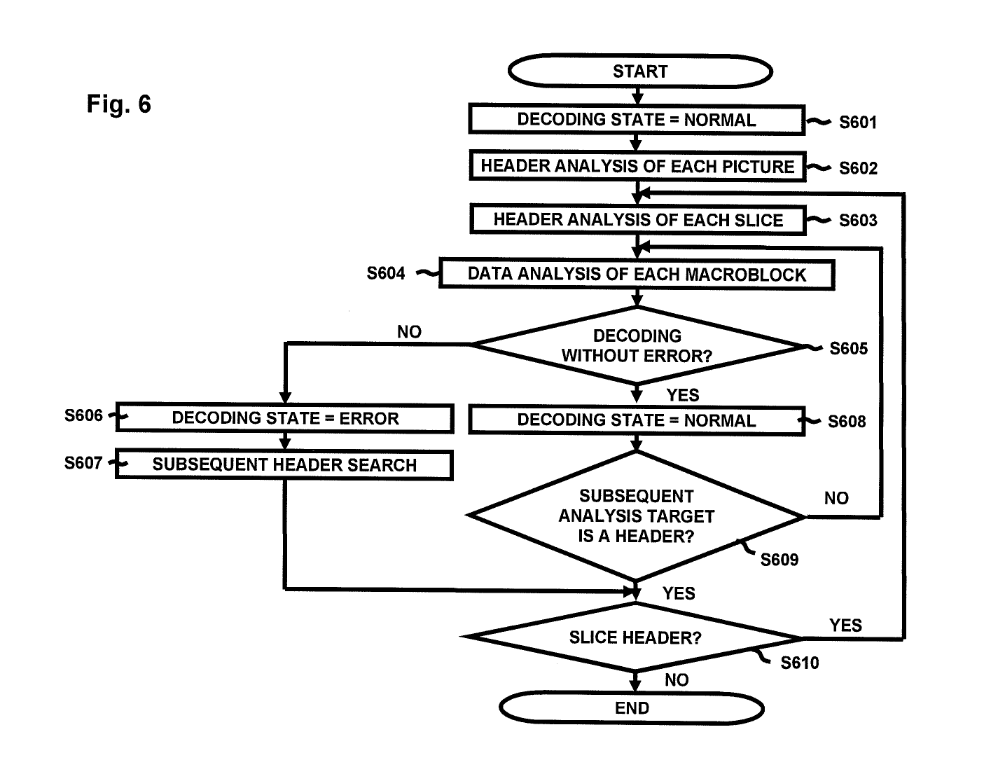

FIG. 6 is a flowchart of transmission error detection processes performed by the variable-length decoding means 307 according to this embodiment.

Upon receipt of the first bit stream 313, the variable-length decoding means 307 starts a picture process. The picture process is a process to be performed in a picture layer. In the picture process, whether there is a decoding error in the first bit stream 313 is determined. The variable-length decoding means 307 divides one picture into slices with 16 lines and then divides each slice into multiple macroblocks (a luminance block of 16 pixels×16 lines and two color difference blocks of 8 pixels×8 lines). Further, the variable-length decoding means 307 divides the luminance block, which is a macroblock, into blocks (8 pixels×8 pixels).

First, the variable-length decoding means 307 initializes the decoding state of each picture included in the first bit stream 313 to set the decoding state to “normal” (S601).

Then, the variable-length decoding means 307 performs a header analysis of each picture (S602). Specifically, the variable-length decoding means 307 performs a header analysis of each picture to identify a picture with respect to which a determination whether there is a decoding error is to be made.

Subsequently, the variable-length decoding means 307 performs a header analysis of each slice of a picture identified in S602 (S603). Specifically, the variable-length decoding means 307 divides a picture into multiple slices with 16 lines. Then, the variable-length decoding means 307 performs a header analysis of each slice to identify a slice with respect to which a determination whether there is a decoding error is to be made.

Subsequently, the variable-length decoding means 307 performs a data analysis of each macroblock included in a slice identified in S603 (S604). Specifically, the variable-length decoding means 307 determines whether there is a decoding error in any macroblock (S605).

If the variable-length decoding means 307 determines that there is a decoding error in a macroblock (NO in S605), it sets the decoding state to “error” (S606). Then, the variable-length decoding means 307 performs a header search (S607) and determines whether the header is a slice header (S610). If the variable-length decoding means 307 determines that the header is a slice header (YES in S610), it again performs a header analysis of each slice (S603). If the variable-length decoding means 307 determines that the header is not a slice header (NO in S610), it ends the picture process.

If the variable-length decoding means 307 determines that there is no decoding error in any macroblock (YES in S605), it leaves the decoding state intact (“normal”) (S608). Then, the variable-length decoding means 307 determines whether the subsequent analysis target is a header (S609).

If the variable-length decoding means 307 determines that the subsequent analysis target is a header (YES in S609), it determines whether the subsequent analysis target is a slice header (S610). If the variable-length decoding means 307 determines that the subsequent analysis target is a slice header (YES in S610), it again performs a header analysis of each slice (S603). If the variable-length decoding means 307 determines that the subsequent analysis target is not a slice header (NO in S610), it ends the picture process. Also, if the variable-length decoding means 307 determines that the subsequent analysis target is a header (NO in S609), it performs a data analysis of each macroblock (S604).

### Flowchart of Picture Correction Processes

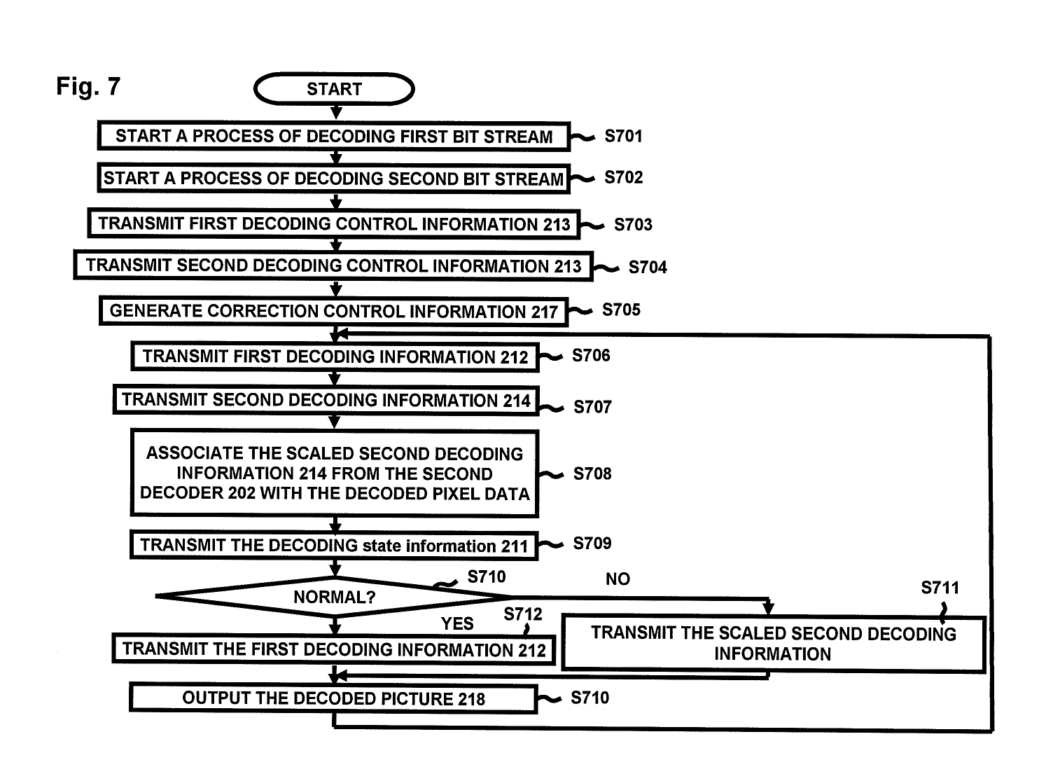

FIG. 7 is a flowchart of picture correction processes performed by the receiver 200 according to this embodiment.

First, the first decoder 201 starts a process of decoding the first bit stream 209 (S701). The second decoder 202 starts a process of decoding the second bit stream 210 (S702). Then, the first decoder 201 transmits the first decoding control information 213 to the correction control means 204 (S703). The second decoder 202 transmits the second decoding control information 215 to the correction control means 204 (S704). The correction control means 203 generates the correction control information 217 from the first decoding control information 213 and second decoding control information 215 (S705).

The first decoder 201 transmits the first decoding information 212 to the correction means 203 (S706). The second decoder 202 transmits the second decoding information 214 to the correction means 203 (S707).

The correction means 203 associates the scale of the second decoding information 214 from the second decoder 202 with the decoded pixel data (S708). Then, the first decoder 201 transmits the decoding state information 211 to the correction means 203 (S709). Then, referring to the decoded state information 211, the correction means 203 determines whether the decoding state of the first bit stream 209 is “normal” (S710).

If the correction means 203 determines that the decoding state is “normal” (YES in S710), it transmits the first decoding information 212 as the corrected decoding information 216 to the first decoder 201 (S712). If the correction means 203 determines that the decoding state is “error” (NO in S710), it transmits the scaled second decoding information as the corrected decoding information 216 to the first decoder 201 (S711).

Subsequently, the first decoder 201 outputs the decoded picture 218 (S713).

### Configuration Diagram of Correction Means 800

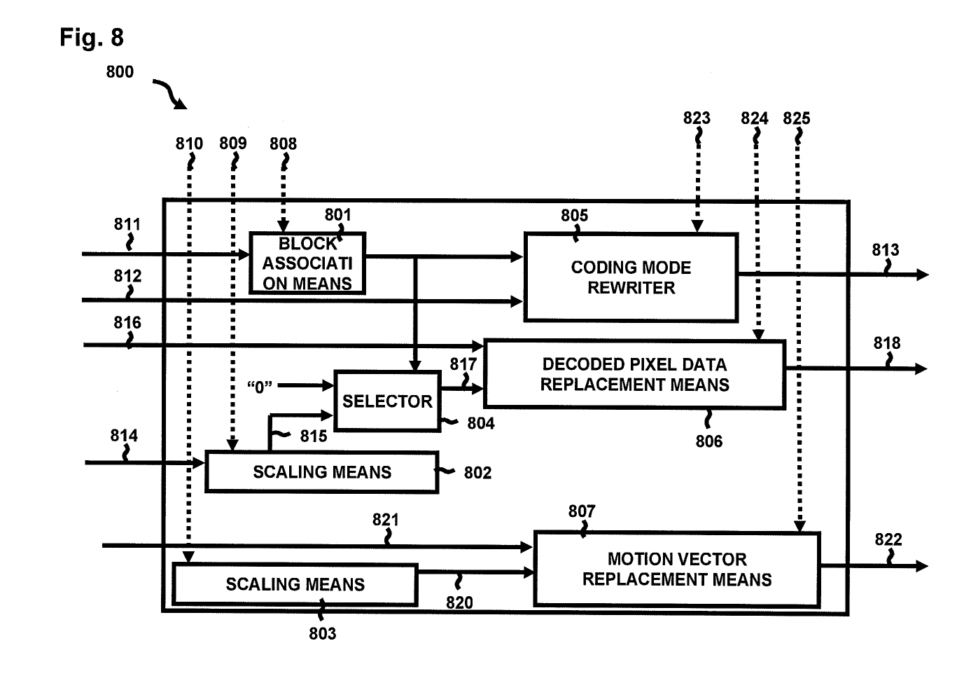

FIG. 8 is a configuration diagram of a correction means 800 according to this embodiment.

The correction means 800 includes a block association means (block associator) 801, a scaling means 802, a scaling means 803, a selection means 804, a coding mode rewrite means 805, a decoded pixel data replacement means 806, and a motion vector replacement means 807.

Upon receipt of first decoding control information and second decoding control information, a correction control means (not shown) generates block position association information 808 and scaling information 809 and scaling information 810. In this case, the correction control means receives the first decoding control information from a first decoder and the second decoding control information from a second decoder.

Subsequently, the correction control means 204 transmits the block position association information 808 to the block position association means 801. Also, the correction control means transmits the scaling information 809 to the scaling means 802 and the scaling information 810 to the scaling means 803.

The block position association information 808 refers to information indicating the association between the macroblock position of the first frame and that of the second frame. The scaling information 809 refers to information to be used to compensate for a difference in resolution between the first and second frames. The scaling information 810 refers to information to be used to compensate for a difference in scale between the respective motion vectors of the first and second frames.

The block association means 801 receives second coding mode information 811 from the second decoder. Then, the block association means 801 associates the macroblock position of the first frame with that of the second frame using the block position association information 808 so as to identify the macroblock position of the second frame corresponding to that of the first frame. Then, the block association means 801 identifies the coding mode of the identified macroblock position of the second frame using the second coding mode information 811. The identified coding mode of the second frame is the coding mode of the macroblock position of the second frame corresponding to the macroblock position of the first frame. Then, the block association means 801 transmits the identified macroblock position of the second frame and the identified coding mode of the macroblock position of the second frame to the coding mode rewrite means 805 and selection means 804.

The coding mode rewrite means 805 receives the first coding mode information 812 from a variable-length decoding means of the first decoder. Also, the coding mode rewrite means 805 receives the coding mode of the second frame corresponding to the macroblock position of the first frame from the block association means 801. Thus, the coding mode rewrite means 805 replaces the coding mode of the macroblock position, where a transmission error has occurred, included in the first coding mode information 812 with the coding mode of the corresponding second frame and outputs resultant coding mode information 813 to a selection means of the first decoder. The coding mode information 813 here is information indicating whether the first coding mode is intra-frame coding mode or interframe prediction coding mode. In the coding mode information 813, the coding mode of the macroblock position where the transmission error has occurred is the coding mode of the second frame.

The scaling means 802 receives second decoded pixel data 814 from the second decoder. Also, the scaling means 802 receives the scaling information 809 from the correction control means. Then, the scaling means 802 converts parameters indicating the macroblock position of the second frame into parameters indicating that of the first frame according to the scaling information 809 so as to enlarge the macroblock position of the second frame to that of the first frame to generate scaling decoded pixel information 815. Then, the scaling means 802 transmits the scaling decoded pixel information 815 to the selection means 804.

The decoded pixel data replacement means 806 receives the first decoded pixel data 816 from an IQ/IDCT of the first decoder. Also, the decoded pixel data replacement means 806 receives the scaling decoded pixel information 817 from the selection means 804. Then, the decoded pixel data replacement means 806 replaces the macroblock where a transmission error has occurred in the first frame with the enlarged macroblock of the second frame using the scaling decoded pixel information 817 and first decoded pixel data 816 so as to generate decoded pixel data 818. Then, the decoded pixel data replacement means 806 transmits the decoded pixel data 818 to a selection means and an adder included in the first decoder. Then, if the coding mode is inter-frame coding, the selection means 804 transmits “0” as the scaling information 817 to the decoded pixel data replacement means 806; if the coding mode is intra-frame coding, the selection means 804 transmits the “scaling information 815” as the scaling information 817 to the decoded pixel replacement means 806.

The scaling means 803 receives second motion vector information 819 from the second decoder. Also, the scaling means 803 receives the scaling information 810 from the correction control means. Then, the scaling means 803 identifies the motion vector of the macroblock position of the second frame for correcting a motion vector of the macroblock position of the first frame using the second motion vector information 819. Then, the scaling means 803 enlarges the identified motion vector of the macroblock position of the second frame to the scale of the motion vector of the macroblock position of the first frame so as to generate the motion vector information 330. Then, the scaling means 303 transmits motion vector information 820 to the motion vector replacement means 807.

The motion vector replacement means 807 receives the first motion vector information 821 from the variable-length decoding means of the first decoder. Also, the motion vector replacement means 807 receives the motion vector information 820 from the scaling means 803. Then, the motion vector replacement means 807 transmits motion vector information 822 to a motion compensation means of the first decoder. The motion vector information 822 is information obtained by replacing the motion vector of the macroblock position where a transmission error has occurred, included in the first motion vector information 821 with a motion vector obtained by enlarging the motion vector of the corresponding second frame to the scale of the motion vector of the macroblock position of the first frame. The correction means 800 is characterized in that it determines whether the transmission error position (error area) is a moving picture portion or a still picture portion according to the motion vector information 821. More specifically, the motion vector replacement means 807 determines whether the macroblock where the transmission error has occurred is a moving picture portion or a still picture portion according to the motion vector information 821. If the correction means 800 determines that the position where the transmission error has occurred is a still picture portion, the first decoder outputs a first frame, where the error has yet to occur, stored in the frame memory. Since the correction means 800 corrects the data representing a difference between the first frames using the data representing a difference between the second frames, the picture quality of the first frame degrades only by the difference data. Thus, degradation in picture quality due to correction is reduced.

Then, the first decoder transmits decoding state information 823, decoding state information 824, and decoding state information 825 to the coding mode rewrite means 805, decoded pixel data replacement means 806, and motion vector replacement means 807, respectively. Thus, the coding mode rewrite means 805, decoded pixel data replacement means 806, and motion vector replacement means 807 each determine whether there is a transmission error in the first frame and, if there is a transmission error, identify the position where the error has occurred.

The receivers 200 and 500 and the receiver including the correction means 800 for receiving simulcasts according to this embodiment each correct a picture transmitted in a 12-segment broadcast using a picture transmitted in a one-segment broadcast and outputs the corrected picture; however, these receivers may correct a picture transmitted in a one-segment broadcast using a picture transmitted in a 12-segment broadcast.

What is claimed is:

1. A method for reproducing moving pictures upon receiving simulcast first bit stream and second bit stream, the first bit stream being obtained by encoding a moving picture, the second bit stream being obtained by encoding the moving picture, the method comprising:
receiving the first bit stream and the second bit stream simultaneously;
decoding the first bit stream into a first moving picture comprising a first series of frames;
decoding the second bit stream into a second moving picture a second series of frames;
detecting an error in the first bit stream which disturbs reproduction of a particular frame from the first bit stream; and
correcting the error in the first bit stream by supplementing correction data generated from data indicative of a difference between adjacent frames in the second moving picture, the correction data being used to reproduce a frame to replace the particular frame on the basis of a immediately preceding frame in the first picture.

2. The method according to claim 1, wherein the correction step generates the correction data by correcting difference data indicative of a difference between adjacent frames in the first moving picture by using the data indicative of a difference between adjacent frames in the second moving picture.

3. The method according to claim 1, wherein the correcting step generates the correction data for correcting the error by compensating for a difference in resolution between the first and second moving pictures in accordance with the detection of the error.

4. The method according to claim 1, wherein the correcting step generates the correction data for correcting the error by compensating for a difference in motion vector resolution between the first and second moving pictures in accordance with the detection of the error.

5. The method according to claim 1, wherein the correcting step determines whether the error is a moving picture portion or a still picture portion, and when the correcting step determines the error is the still picture portion, the first decoding step outputs a frame preceding the particular frame.

6. An apparatus for reproducing moving pictures upon receiving simulcast first bit stream and second bit stream, the first bit stream being obtained by encoding a moving picture, the second bit stream being obtained by encoding the moving picture, the apparatus comprising:
a reception unit for receiving the first bit stream and the second bit stream simultaneously;
a first decoder for decoding the first bit stream into a first moving picture comprising a first series of frames;
a second decoder for decoding the second bit stream into a second moving picture a second series of frames;
an error detection unit for detecting an error in the first bit stream which disturbs reproduction of a particular frame from the first bit stream; and
a correction unit for correcting the error in the first bit stream by supplementing correction data generated from data indicative of a difference between adjacent frames in the second moving picture, the correction data being used to reproduce a frame to replace the particular frame on the basis of a immediately preceding frame in the first picture.

7. The apparatus according to claim 6, wherein the correction unit generates the correction data by correcting difference data indicative of a difference between adjacent frames in the first moving picture by using the data indicative of a difference between adjacent frames in the second moving picture.

8. The receiver according to claim 6, wherein the correction unit generates the correction data for correcting the error by compensating for a difference in resolution between the first and second moving pictures in accordance with the detection of the error.

9. The receiver according to claim 6, wherein the correction unit generates the correction data for correcting the error by compensating for a difference in motion vector resolution between the first and second moving pictures in accordance with the detection of the error.

10. The receiver according to claim 6, wherein the correction unit determines whether the error is a moving picture portion or a still picture portion, and when the correcting step determines the error is the still picture portion, the first decoding step outputs a frame preceding the particular frame.
